(19) United States
(12) Patent Application Publication
(10) Pub. No.: US 2005/0077346 A1
(43) Pub. Date: Apr. 14, 2005

(54) Permit mail, payment system and postal infrastructure thereof

(76) Inventors: Rana Dutta, Easton, CT (US); George M. Brookner, Norwalk, CT (US)

Correspondence Address: PERMAN & GREEN, 425 POST ROAD, FAIRFIELD, CT, 06824, US

(21) Appl. No.: 10/940,216

(22) Filed: Sep. 13, 2004

Related U.S. Application Data
(60) Provisional application No. 60/503,052, filed on Sep. 12, 2003.

(51) Int. Cl. G06F 17/00

(52) U.S. Cl. 235/375

(57) ABSTRACT

A method of permit mailing includes encoding information about a permit holder and information about a batch mailing into a barcode, imprinting the barcode onto a plurality of mail pieces of the batch mailing, and utilizing the encoded information to charge the permit holder for the batch mailing.

This application claims the benefit of U.S. Provisional Application No. 60/503,052, filed 12 Sep. 2003.

### BACKGROUND

The disclosed embodiments relate to permit mailing, a payment system, and a postal infrastructure thereof.

### BRIEF DESCRIPTION OF RELATED DEVELOPMENTS

Historically, a carrier, for example, the USPS, has required a postal user to group permit mailings, also referred to as bulk mailings, in quantities of at least 200 identical pieces. The carrier generally requires forms to be filled out with the user's name, permit number, date, number of pieces, cost per piece and total postage to be charged to the account of the permit number. The mailing is generally required to be presented to the carrier location, for example, a post office, issuing the permit number. Permit imprint mailings with postage paid by advance deposit account must be presented to the USPS for weighing. A mailer may obtain a permit to use a permit imprint indicia and pay postage in cash before or at the time of mailing by submitting proper forms and the applicable fee to the post office where mailings are made. There is no other fee for the use of a permit imprint indicia as long as the permit remains active. A permit holder must provide complete information about mailings or mailpieces for which postage was paid using its company permit imprint. Typical of this information is the requirement for a permit holder to keep records of each mailing paid for a period of one year. The existing permit mail system is conducive to mistakes and fraud, in that the accounting for actual mailings against the revenues for those mailings may not reconcile, thus more mailings than related revenues, thereto result in an Post estimate loss of up to 10% revenue on permit mail.

### SUMMARY OF THE INVENTION

In one embodiment, the present invention is directed to a method of permit mailing. The method includes encoding information about a permit holder and information about a batch mailing into a barcode, imprinting the barcode onto a plurality of mail pieces of the batch mailing, and utilizing the encoded information to charge the permit holder for the batch mailing.

In another embodiment, the present invention includes a permit mail system having a scanner for reading information about a permit holder and information about a batch mailing incorporated into a barcode, a processor for analyzing and storing the barcoded information, and a billing function for charging a permit holder's account for the batch mailing.

### BRIEF DESCRIPTION OF THE DRAWINGS

The foregoing aspects and other features of the disclosed embodiments are explained in the following description, taken in connection with the accompanying drawings, wherein:

FIG. 1 shows a typical permit mail indicia with the addition of a barcode according to the invention;

FIG. 2 shows a mail piece with permit mail information encoded into a postage proof of payment two dimensional barcode in conformance with the Information Based Indicia (IBI) standard;

FIG. 3 presents a system utilizing the present invention;

FIG. 4 depicts a process by which the present invention may be implemented; and

FIG. 5 shows how a permit holder may have the ability to access their account through the infrastructure.

### DETAILED DESCRIPTION OF THE EMBODIMENT(S)

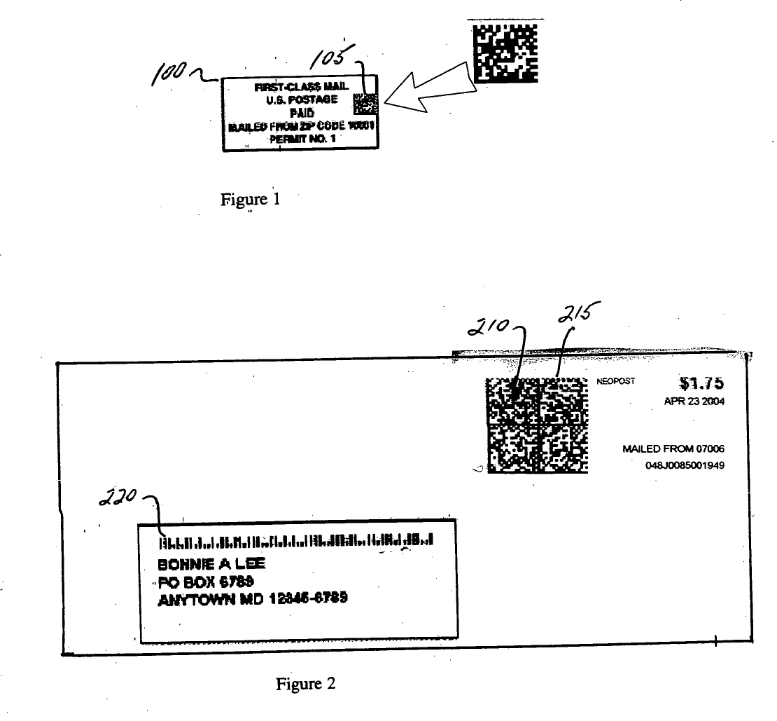

FIG. 1 shows a typical permit mail indicia 100 with the addition of a barcode 105 according to the invention. The barcode 105 may be a two dimensional barcode and generally includes information related to permit mail, for example, information identifying the mail piece and the permit holder. In one embodiment, the barcode 105 includes a permit number and an identifier that identifies the particular batch of permit mail being submitted to the carrier. The zip code from which the mail piece was mailed may also be included.

The barcode 105 may be include a secured representation of authenticity that uses public key encryption techniques with security implemented in accordance with Information Based Indicia (IBI) standards of the USPS. The barcode 105 may be the same for all mail pieces in a particular permit mail batch, thus identifying the batch of mail and associating it to a particular permit.

Alternately, the barcode 105 could include further information that identifies the particular mail piece and thus may be unique for each mail piece. The barcode 105 may include even further information, for example, additional information about the permit holder, the mail class, the addressee, the date of posting, the total number of pieces in the batch, the cost per piece, the total mailing cost of the batch, etc.

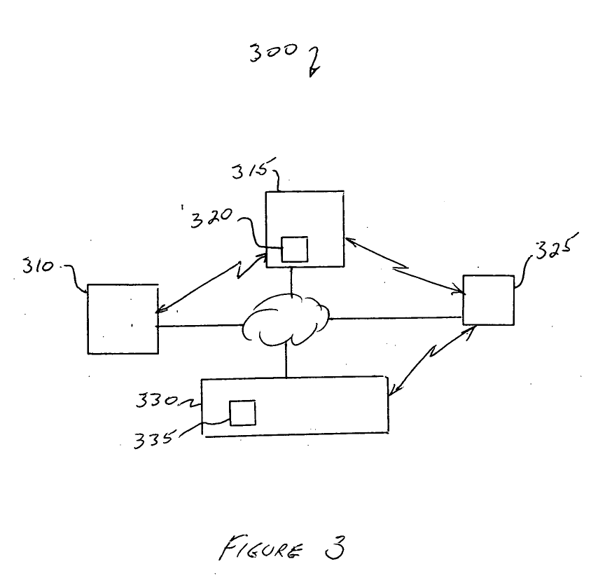

FIG. 2 shows another embodiment of the present invention. In this embodiment, information 210 related to permit mail is part of, and integral to a postage proof of payment two dimensional barcode 215 in conformance with the Information Based Indicia (IBI) standard. Thus, a separate barcode representing the permit mail information is not required.

Barcode 215 may be the same for all mail pieces in a particular permit mail batch, thus identifying the batch of mail and associating it to a particular permit. In the alternative, barcode 215 could include further information that identifies the particular mail piece similar to barcode 105 (FIG. 1). Barcode 215 may be unique for each mail piece and may include information such as additional information about the permit holder, the mail class, the addressee, the date of posting, the total number of pieces in the batch, the cost per piece, the total mailing cost of the batch, etc.

Barcode 105, 215 may securely identify the permit holder using cryptographic techniques related to public and private keys such that the public and private keys are adapted to uniquely identify batch mailings or individual mail pieces.

FIG. 2 also shows an address label with a planet code 220. The planet code may provide addressee information that may be used instead of, or in addition to, the information in barcode 215. Generally, the addressee information may be used for confirmation of provided service that may be offered by the carrier or by a postal service provider.

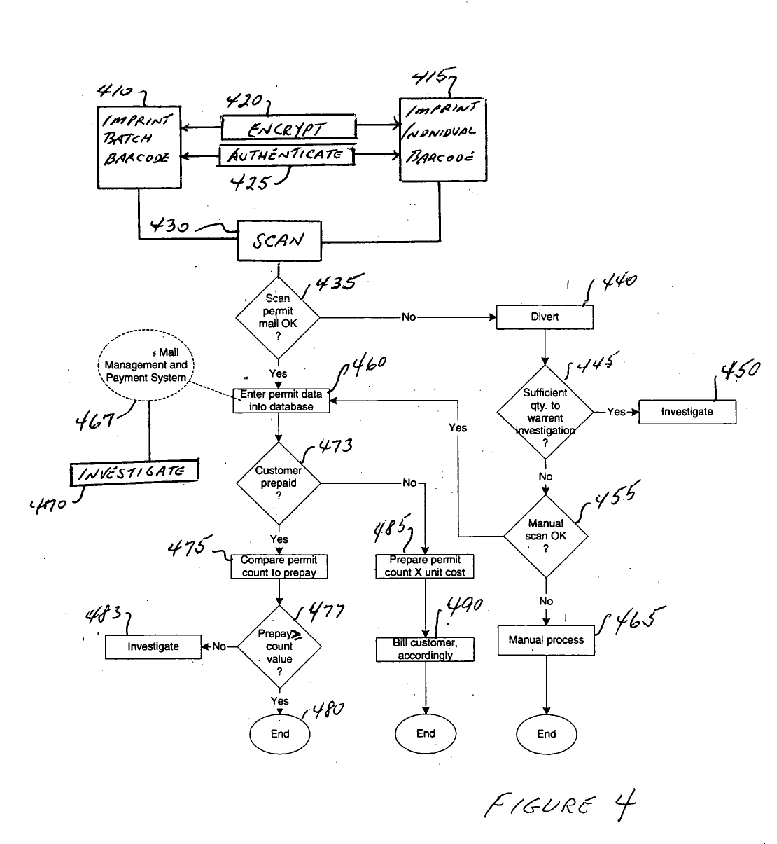

FIG. 3 shows an example of a system 300 that may be used in accordance with the present invention. The various components of the infrastructure 300 may be provided by a permit holder's equipment, a postal service provider infrastructure, or a postal carrier infrastructure, or any combination thereof. Connections between the components may be accomplished using any suitable technology or protocol, including wired, wireless, electrical, optical, or any other appropriate connection technique.

A scanner 310 is generally used to read the barcode 105, 215. The information from the barcode 105, 215 may be conveyed to a processor 315 for analysis and storage in a database 320. Processor 315 may also provide an information path to the permit holder's equipment 325 and a billing function 330. Billing function 330 may hold information 335 related to a permit holder's account. Billing function 330 may be operated by a postal service provider or by a postal carrier, for example, the USPS. One example of a particular billing function may include the USPS PostalOne mail acceptance and payment process. It is contemplated that in one embodiment, the present invention could utilize the USPS PostalOne billing function to provide and update permit mailing accounts, to bill and receive payments for permit mailing accounts, and make those accounts accessible to a permit holder.

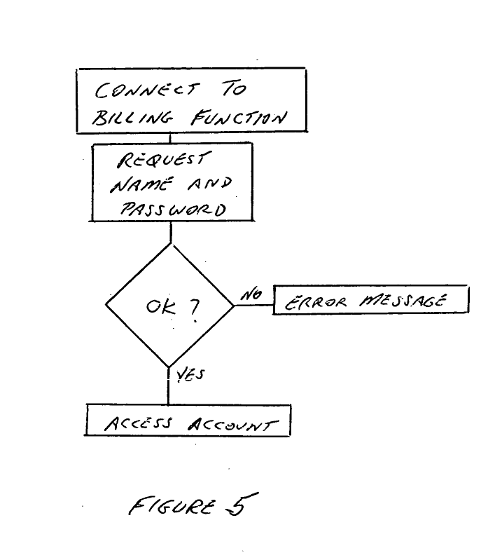

FIG. 4 depicts a process by which the present invention may be implemented. A batch of mail pieces may be imprinted with the same barcode identifying the batch of mail and associating it to a particular permit 410. In the alternative, the barcode may include information identifying the particular mail piece and therefore may be unique for each mail piece 415.

The barcode may be encrypted using public key, private key standards 420 and may also be authenticated with a digital signature 425. The encryption and authentication processes are useful in preventing fraudulent mailings, as well as attempts to duplicate valid barcodes and reapply the duplicate barcodes to a second mailing.

Upon receipt by a carrier, the barcode is scanned and checked for validity 435. If the barcode does not scan correctly or does not appear to be valid, the mail piece is diverted 440. The quantity of diverted mail pieces is tested periodically 445 to determine if the number of unsuccessful scans warrants an investigation. In the event that a sufficient quantity of diverted mail pieces exist, an investigation may commence 450. If the quantity of diverted mail pieces is not enough to warrant an investigation, a manual scan of the diverted mail pieces may be made 455. If the manual scan is successful, the barcode information is entered into the database 460. If the manual scan is unsuccessful, the diverted mail pieces may be manually processed 465.

If, in block 435, the scan is successful, data from the barcode is entered into the database 460. A mail management and payment system 467 operates to generally maintain database integrity, and to guard against duplicate barcode information in the database. In the event that database integrity is compromised, for example, duplicate encrypted barcodes are encountered, an investigation could be initiated 470.

Once the barcode data has been entered into the database, the processor 315 may interrogate the billing function 330, or otherwise determine if the permit holder has a prepaid account to pay for permit mailings 473. If so, the postage value for the total number of mail pieces mailed using the permit holder's account is compared to the value remaining in the permit holder's prepaid account 475. If the value remaining in the permit holder's prepaid account is greater than or equal to the value for the total number of mail pieces mailed using the permit holder's account 477, the process ends 480. If the value remaining in the permit holder's prepaid account is not greater than or equal to the value for the total number of mail pieces mailed using the permit holder's account, an investigation into the permit holder's account may commence 483.

If the permit holder does not have a prepaid account to pay for permit mailings 473, the processor 315 operates with the billing function 330 to compute the cost of the batch mailing by multiplying the count of the mail pieces by the unit cost of the mail pieces. The processor 315 and billing function 330 may operate to include other costs such as administrative costs, late fees, etc. The permit holder is then billed accordingly 490. In one embodiment, a permit holder may provide authorization to bill against the permit holder's credit card or debit card.

Referring to FIGS. 3 and 5, as another feature of the present invention, a permit holder may be provided with the ability to access their account at any time. Generally, a permit holder will access their account 335 on the billing function 330 by connecting to the billing function. The billing function generally responds by requesting a login name and a password. If the permit holder provides the correct login name and password, the permit holder is allowed to access information regarding their account. Otherwise, an error message is generated.

The permit holder's account information generally includes, among others, date and time of mailings, count and cost of mailing, credit remaining, account charges, etc. The account information may also include an accounting of the number of mail pieces processed by the carrier against the number of mail pieces identified by the permit holder for a particular batch mailing.

Furthermore, the permit holder's account information may include tracking information and delivery confirmation that may be provided by the carrier or the postal service provider. For example, the system described herein may couple to a carrier service such as the USPS CONFIRM program and extract information from the this program to provide a permit holder with tracking and delivery information for batches or even individual mail pieces.

The present invention is advantageous because it eliminates the need for the conditional requirements placed upon permit mailings and the manual manifestations of accounting for the permit versus the actual mailing quantities. By utilizing a scanning and verification processes, and coupling the processes with a postal service, permit holder, or carrier's infrastructure, uncontrolled mailings and payments may be tightly automated and controlled.

By using at least one of the barcodes and optionally the planet code of FIGS. 1 and 2, the services and accounting associated with permit mail may be greatly enhanced. Upon scanning of the permit mail barcode or planet code into a postal service or carrier system or infrastructure, more accurate billing and delivery confirmation services may be provided. In addition, permit mail may be tracked, accounted for, and billed accurately, removing the highly intensive, and inaccurate manual processes for handling permit mail in the existing environment.

Once permit mailing data from the barcode is collected in data base 320, processor 315 may be used to organize, parse, sort, or otherwise process the data to provide a postal service provider, a carrier, or a permit holder with a host of information about permit mailings, including demographic profiles of how the permit mail service is utilized, and insight on ways and means to improve or add to the service.

Thus, the present invention automates the permit mail process such that permit batches are scanned against a permit holder's account. The system provides accurate billing for permit holders for permit services following permit mailings. The present invention provides barcode information that includes permit related information with the permit indicia such that the mail piece may be identified by scanning the indicia. The barcoded information on the permit indicia may be used to charge back to the permit owner's account.

While particular embodiments have been described, various alternatives, modifications, variations, improvements, and substantial equivalents that are or may be presently unforeseen may arise to Applicant's or others skilled in the in the art. Accordingly, the appended claims as filed, and as they may be amended, are intended to embrace all such alternatives, modifications, variations, improvements and substantial equivalents.

1. A method of permit mailing comprising:
encoding information about a permit holder and information about a batch mailing into a barcode;
imprinting the barcode onto a plurality of mail pieces of the batch mailing; and
utilizing the encoded information to charge the permit holder for the batch mailing.

2. The method of claim 1, wherein the batch mailing information includes a permit number and an identifier that identifies the batch mailing being submitted to a carrier.

3. The method of claim 2, wherein the barcode includes information securely identifying the permit holder using cryptographic public and private keys such that the public and private keys are adapted to uniquely identify the batch mailing.

4. The method of claim 1, wherein the batch mailing information includes a permit number and an identifier that uniquely identifies each of the plurality of mail pieces.

5. The method of claim 4, wherein the barcode includes information securely identifying the permit holder using cryptographic public and private keys such that the public and private keys are adapted to uniquely identify each of the plurality of mail pieces.

6. The method of claim 1, wherein the barcode is a postage proof of payment two dimensional barcode in conformance with the Information Based Indicia (IBI) standard.

7. A permit mail system comprising:
a scanner for reading information about a permit holder and information about a batch mailing incorporated into a barcode;
a processor for analyzing and storing the barcoded information; and
a billing function for charging a permit holder's account for the batch mailing.

8. The system of claim 7, wherein the batch mailing information includes a permit number and an identifier that identifies the batch mailing being submitted to a carrier.

9. The system of claim 8, wherein the barcode includes information securely identifying the permit holder using cryptographic public and private keys such that the public and private keys are adapted to uniquely identify the batch mailing.

10. The system of claim 7, wherein the batch mailing information includes a permit number and an identifier that uniquely identifies each of the plurality of mail pieces.

11. The system of claim 10, wherein the barcode includes information securely identifying the permit holder using cryptographic public and private keys such that the public and private keys are adapted to uniquely identify each of the plurality of mail pieces.

12. The system of claim 7, wherein the barcode is a postage proof of payment two dimensional barcode in conformance with the Information Based Indicia (IBI) standard.

13. The system of claim 7, wherein the billing function provides the permit holder with access to the permit holder's account.
